(19) United States
(12) Patent Application Publication
(10) Pub. No.: US 2015/0074941 A1
(43) Pub. Date: Mar. 19, 2015

(54) DOOR HINGE DEVICE

(71) Applicant: Hyundai Best Metal Co., Ltd., Namyangju-si, Gyeonggi-do (KR)

(72) Inventor: Hyun-Seok Park, Gyeonggi-do (KR)

(21) Appl. No.: 14/386,844

(22) PCT Filed: Apr. 9, 2013
(86) PCT No.: PCT/KR2013/002963

§ 371 Date: Sep. 22, 2014

(30) Foreign Application Priority Data
Apr. 9, 2012 (KR) 10-2012-0036620

(51) Int. Cl. E05F 3/20; E05D 11/08; E05D 11/04; E05D 7/00

(52) U.S. Cl. CPC E05F 3/20; E05D 7/00; E05D 11/081; E05D 11/04
USPC 16/54

(57) ABSTRACT

The present invention relates to a door hinge device using hydraulic pressure so that a door can be opened or closed through rotations, and more particularly, to a door hinge device that can be built at a lower cost, facilitates the opening and closing of the door, has improved durability for a longer service life, can control the angle at which the door is opened and fixed, and can prevent the door from being suddenly opened.

### TECHNICAL FIELD

The present invention relates to a hinge device using hydraulic pressure so that a door can be opened or closed through rotations, and more particularly, to a door hinge device that can be built at a lower cost, facilitates the opening and closing of the door, has improved durability for a longer service life, can control the angle at which the door is opened and fixed, and can prevent the door from being suddenly opened.

### BACKGROUND ART

A hinged swing door designed to be opened and closed as a user pushes or pulls it in an inward or outward direction is a typical type of a door structure and is generally installed inside or outside a building. In case that such a hinged swing door is installed at an entrance of a building, it may be randomly opened or closed even by a predetermined external force, for example, by wind, etc. Even when it is installed inside a building, it may be randomly opened or closed at high speed by even small force, which may lead to the damages of the door and causing accident. In order to prevent such problems of a hinged swing door, there is a shock absorber designed to decelerate the opening and closing speeds of a door when a predetermined level of force is applied to the hinged swing door.

As a typical shock absorber widely used in related arts, there is a floor-mounted hinge characterized in that a groove is formed on a bottom surface of a door frame, and the floor-mounted hinge is fixedly inserted in the groove, and an end of a rotary shaft is inserted in the floor-mounted hinge, thus controlling the opening and closing speeds of the door. Since the floor-mounted hinge needs some parts for controlling the opening and closing speeds of the door, the device becomes bulky. In order to use the above-mentioned floor-mounted hinge, the door frame may be grooved as deep as the volume of the floor-mounted hinge, so installation needs hard work, and cost increases.

In recent years, a hydraulic pressure shock absorber attached to a door and designed to control the opening and closing speeds of the door using hydraulic pressure is being developed; however such shock absorber is not easy to use and has bad durability because friction between inner parts increases during the use of the product, and it is impossible to adjust the angle at which the door is opened and fixed and effectively control the opening and closing speeds of the door when the door is opened or closed using only hydraulic pressure.

### DISCLOSURE OF THE INVENTION

### Technical Problem

Accordingly, the present invention is made in an effort to resolve the aforementioned problems.

It is an object of the present invention to provide a door hinge device which makes it possible to save construction cost in such a way to easily install a door hinge device at an upper side or a lower side of a door.

It is another object of the present invention to provide a door hinge device which makes it possible to conveniently open or close a door because a roller rolls along an outer side surface of a protrusion part when a door is opened and closed and enhance durability in such a way to minimize the friction between installed parts, thus reducing any errors at the device and obtaining a longer service life.

It is further another object of the present invention to provide a door hinge device which makes it possible to adjust the angle at which a door is opened and fixed in such a way to provide a plurality of roller mounting parts formed at regular intervals at an outer side surface of a protrusion part and change the roller mounting parts on which the roller is mounted.

It is still further another object of the present invention to provide a door hinge device which makes it possible to prevent any accident which may occur as a door is suddenly closed, in such a way to provide a quick rotation prevention part which comes into contact with one side surface of the protrusion part when the contacting protrusion part and roller depart from each other while the door is being closed.

### Solution of Problem

In order to achieve the above objects, the present invention may be implemented by means of exemplary embodiments based on the following constructions.

According to an exemplary embodiment of the present invention, there is provided a door hinge device comprising an engaging accommodation part which is engaged to the door and moves together with the door and includes an accommodation space part configured to accommodate fluid; a shaft part which is disposed in the accommodation space part and of which one end protrudes from the engaging accommodation part and is fixed at a door frame; a movement part which is disposed in the accommodation space part and is connected to the shaft part so that the movement part reciprocates in a longitudinal direction of the accommodation space part and rotates at a predetermined angle about the shaft part; and an elastic part which is disposed in the accommodation space part and is configured to pressurize an end of the movement part, wherein the shaft part comprises a protrusion part eccentrically protruding from an outer side surface, and the movement part comprises a roller part formed at one side and having a roller rolling about a roller shaft, and when the door is opened, the movement part rotates about the shaft part, and the roller rolls along an outer side surface of the protrusion part, so the movement part moves in a longitudinal direction of the accommodation space part, thus pressurizing the elastic part.

According to another exemplary embodiment of the present invention, in the door hinge device, the protrusion part comprises a roller mounting part which is depressed from an outer side surface to an inner side, one side surface of the roller being mounted on the roller mounting part, and the door can be opened and fixed in such a way that the roller is mounted on the roller mounting part.

According to further another exemplary embodiment of the present invention, in the door hinge device, there are provided a plurality of the roller mounting parts at regular intervals on an outer side surface of the protrusion part, so the angle at which the door is opened and fixed can be changed based on the roller mounting part on which the roller is mounted.

According to still further another exemplary embodiment of the present invention, in the door hinge device, the movement part further comprises a quick rotation prevention part which is formed at one side and comes into contact with the protrusion part when the contacting protrusion part and roller is departed while the door is being closed, for thereby preventing quick rotations of the movement part.

According to still further another exemplary embodiment of the present invention, in the door hinge device, the movement part further comprises a first head contacted with elastic part, a second head disposed at a predetermined interval from the first head, and a connection part interconnecting the first head and the second head, wherein the first head and the second head each include a fluid flow hole which is passed through for fluid to flow.

According to still further another exemplary embodiment of the present invention, in the door hinge device, the movement part further comprises an opening and closing ball movably disposed in the fluid flow hole of the second head, and the fluid flow hole of the second head comprises a first pass through hole formed near the connection part and having a predetermined diameter, and a second pass through hole which extends from the first pass through hole and has a diameter larger than that of the first pass through hole, and the opening and closing ball has a diameter larger than that of the first pass through hole, but smaller than that of the second pass through hole.

According to still further another exemplary embodiment of the present invention, in the door hinge device, the first head further comprises a support shoulder protruding from one side surface and configured to support the roller, and the roller is disposed between a lower surface of the connection part and an upper surface of the support shoulder, and the roller shaft is fixedly inserted in regular sequence in the support shoulder, the roller and the connection part.

According to still further another exemplary embodiment of the present invention, in the door hinge device, the engaging accommodation part is depressed on an inner surface at a predetermined interval and is connected and comprises a fluid flow passage through which the fluid of the accommodation space part flow, and as the door is opened and closed, the second head opens or closes the fluid flow passage.

According to still further another exemplary embodiment of the present invention, in the door hinge device, the engaging accommodation part is depressed on an outer surface and communicates with the fluid flow passage and further comprises a hydraulic pressure adjusting passage in which a hydraulic pressure adjusting part is inserted so as to adjust the amount of fluid flowing through the fluid flow passage.

According to still further another exemplary embodiment of the present invention, in the door hinge device, the fluid flow passage is installed in pair at a front side and a rear side at a predetermined interval, and one fluid flow passage is shorter than the other fluid flow passage, so when the movement part moves in a longitudinal direction of the accommodation space part, the second head opens or closes the one fluid flow passage.

### Advantageous effects

The present invention may have the following advantageous effects from the exemplary embodiments, constructions and applicability below.

The present invention makes it possible to save construction cost in such a way to easily install a door hinge device at an upper side or a lower side of a door.

Also, the present invention makes it possible to conveniently open or close a door because a roller rolls along an outer side surface of a protrusion part when a door is opened and closed and enhance durability in such a way to minimize the friction between installed parts, thus reducing any errors at the device and obtaining a longer service life.

Also, the present invention makes it possible to adjust the angle at which a door is opened and fixed in such a way to provide a plurality of roller mounting parts formed at regular intervals on an outer side surface of a protrusion part and change the roller mounting parts on which the roller is mounted.

Also, the present invention makes it possible to prevent any accident which may occur as a door is suddenly closed in such a way to provide a quick rotation prevention part which comes into contact with one side surface of the protrusion part when the contacting protrusion part and roller depart from each other while the door is being closed.

### BRIEF DESCRIPTION OF THE DRAWINGS

FIG. 1 is a reference view for describing a door structure having a hinge device according to an exemplary embodiment of the present invention.

FIG. 2 is a reference view for describing an engaging relationship of a hinge device according to an exemplary embodiment of the present invention.

FIG. 3 is a disassembled perspective view illustrating a hinge device according to an exemplary embodiment of the present invention.

FIG. 4 is a cross sectional view illustrating an accommodation part body cut along line A-A of FIG. 3.

FIG. 5 is a perspective view illustrating a shaft part used at a hinge device according to an exemplary embodiment of the present invention.

FIG. 6 is a perspective view illustrating a movement part of a hinge device when it is viewed from its lower side according to an exemplary embodiment of the present invention.

FIG. 7 is a cross sectional view illustrating a hinge device cut along line A-A of FIG. 2 in a state that a door is closed.

FIG. 8 is a cross sectional view illustrating a hinge device cut along line B-B of FIG. 2 in a state that a door is closed.

FIG. 9 is a cross sectional view illustrating a hinge device cut along line C-C of FIG. 2 in a state that a door is closed.

FIGS. 10, 11, 12, 13, 14 and 15 are reference views for describing an operational procedure of a hinge device according to an exemplary embodiment of the present invention.

### BEST MODES FOR CARRYING OUT THE INVENTION

The door hinge device according to the present invention will be described with reference to the accompanying drawings. The terms appearing throughout the specification, unless otherwise stated, are same as the terms that a person skilled in the art can easily understand, and if their interpretations collide with the terms used throughout the specification, the interpretations there are subject to the definitions of the specification. The known functions or constructions which may make the subject matters unclear, may be omitted from the descriptions.

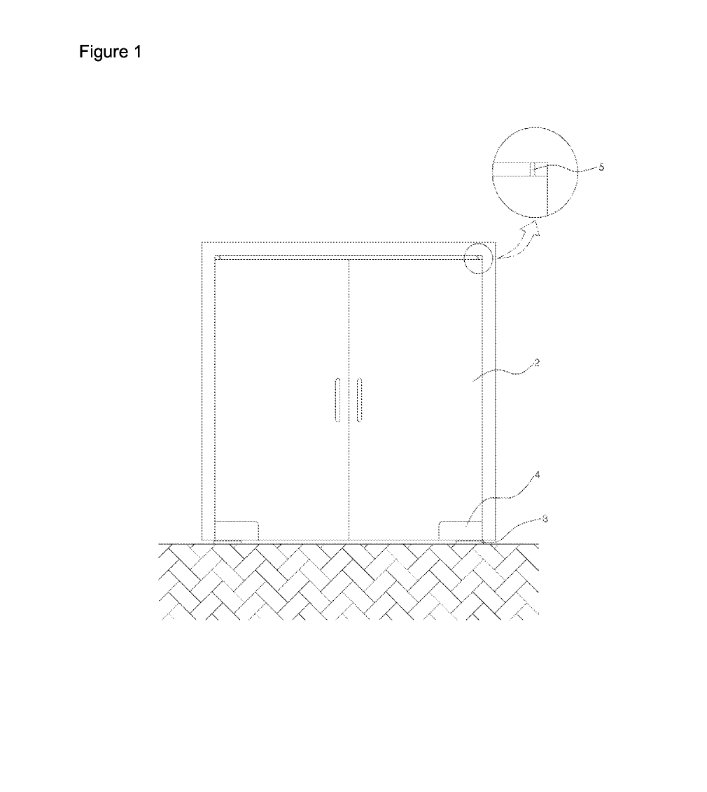

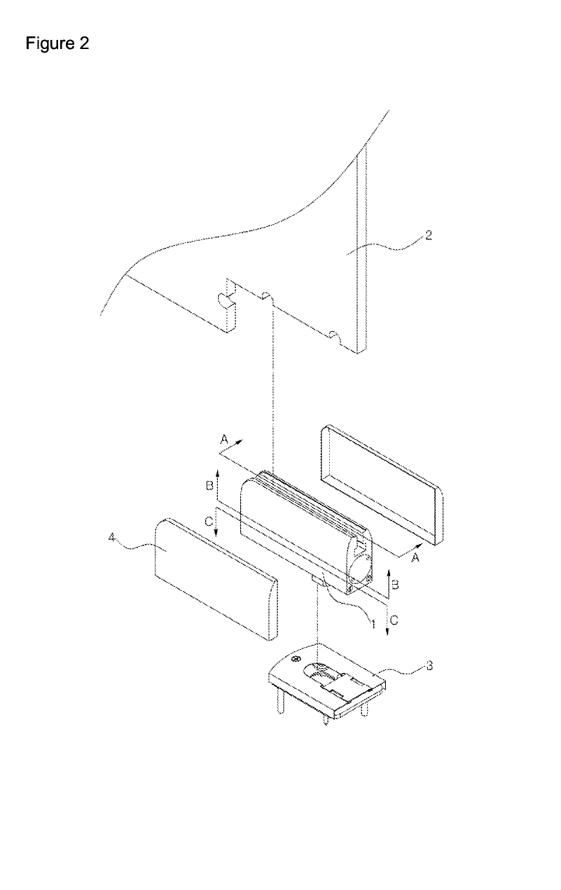

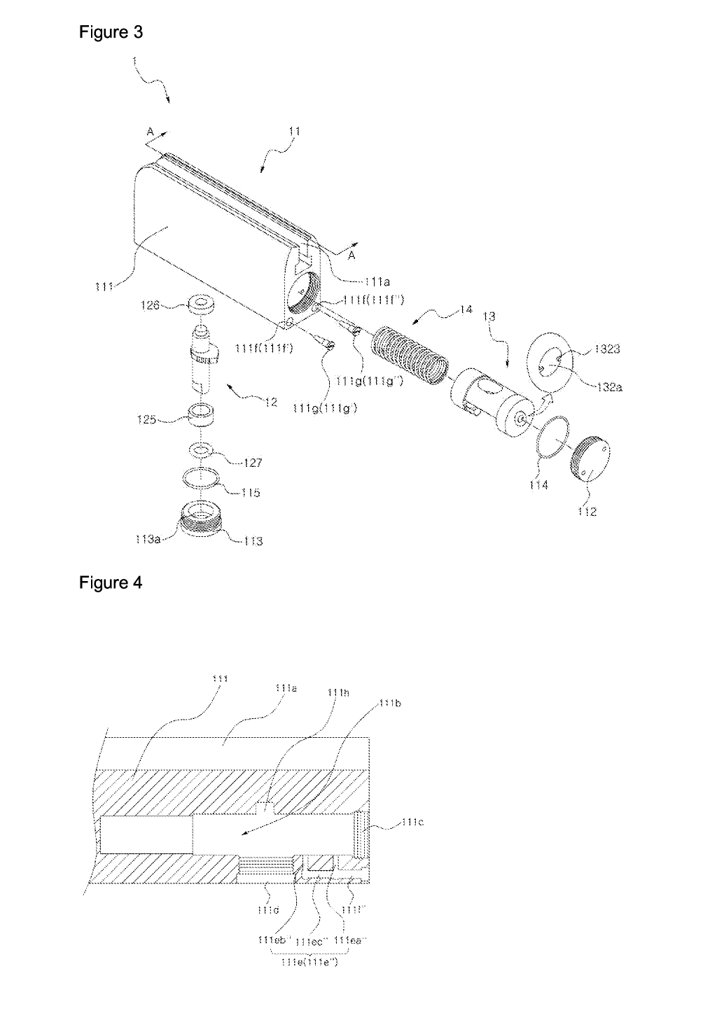

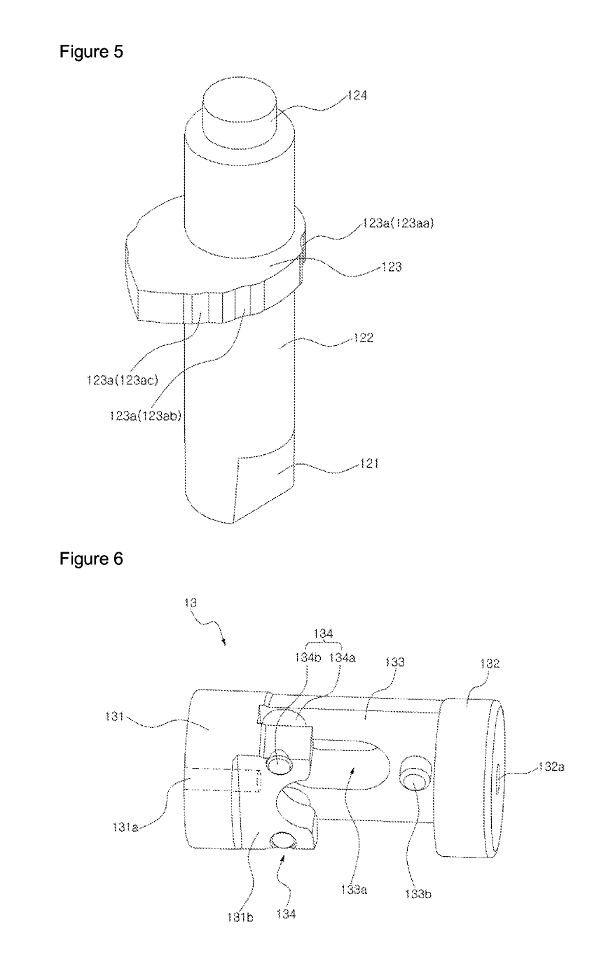

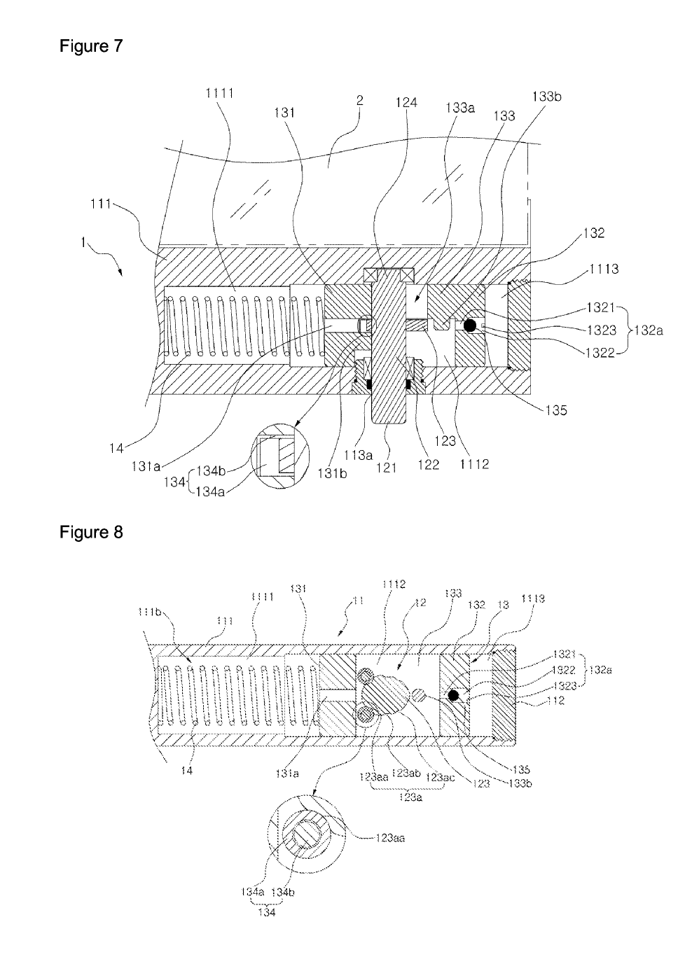

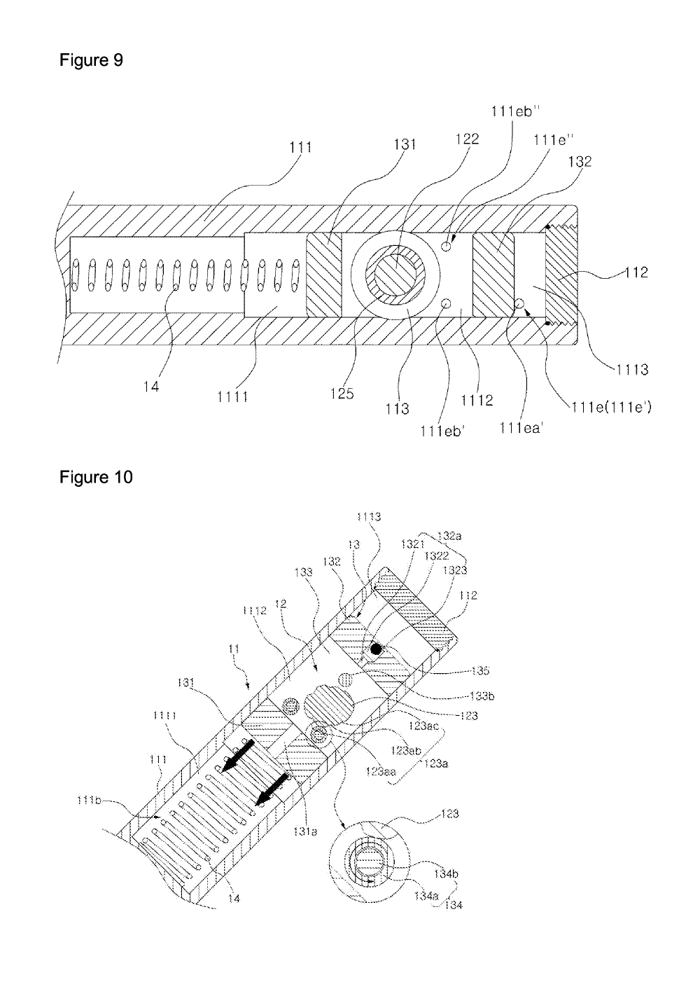

FIG. 1 is a reference view for describing a door structure having a hinge device according to an exemplary embodiment of the present invention. FIG. 2 is a reference view for describing an engaging relationship of a hinge device according to an exemplary embodiment of the present invention. FIG. 3 is a disassembled perspective view illustrating a hinge device according to an exemplary embodiment of the present invention. FIG. 4 is a cross sectional view illustrating an accommodation part body cut along line A-A of FIG. 3. FIG. 5 is a perspective view illustrating a shaft part used at a hinge device according to an exemplary embodiment of the present invention. FIG. 6 is a perspective view illustrating a movement part of a hinge device when it is viewed from its lower side according to an exemplary embodiment of the present invention. FIG. 7 is a cross sectional view illustrating a hinge device cut along line A-A of FIG. 2 in a state that a door is closed. FIG. 8 is a cross sectional view illustrating a hinge device cut along line B-B of FIG. 2 in a state that a door is closed. FIG. 9 is a cross sectional view illustrating a hinge device cut along line C-C of FIG. 2 in a state that a door is closed. FIGS. 10 to 15 are reference views for describing an operational procedure of a hinge device according to an exemplary embodiment of the present invention.

Referring to FIGS. 1 to 15, the hinge device 1 according to an exemplary embodiment of the present invention comprises an engaging accommodation part 11 which is engaged to a door 2 and moves together with the door 2 and has an accommodation space part 111b configured to accommodate fluid, a shaft part 12 which is disposed in the accommodation space part 111b and of which one end protrudes from the engaging accommodation part 11 and is fixed at a door frame, a movement part 13 which is disposed in the accommodation space part 111b and is connected to the shaft part so that the movement part 13 reciprocates in a longitudinal direction of the accommodation space part 111b and is configured to rotate at a predetermined angle about the shaft part 12 and is connected to the shaft part 12, and an elastic part 14 which is disposed in the accommodation space part 111b and is configured to pressurizes an end of the movement part 13, wherein the movement part 13 comprises a roller part 134 formed at one side and having a roller 134a configured to rotate about the roller shaft 134b, and when the door 2 is opened, the movement part 13 rotates about the shaft part 12, and the roller 134a rolls along an outer side surface of the protrusion part 123, so the movement part 13 moves in the longitudinal direction of the accommodation space part 111b, thus pressurizing the elastic part 14.

The engaging relationship of the door hinge device 1 according to an exemplary embodiment of the present invention will be described with reference to FIGS. 1 and 2. A fixing support part 3 is installed on the bottom surface of the building, and a lower end of the door 2 is inserted into an upper end of the hinge device 1, and a cover 4 is covered over an outer surface of the hinge device 1, and the door 2 and the hinge device 1 are engaged, and an end part 121 of the shaft part 12 protruding from a lower side of the hinge device 1 is inserted in the fixing support part 3, and the rotary shaft 5 formed at the upper side of the door 2 is rotatably inserted in the building. The end part 121 of the shaft part 12 is not rotatable since it is fixedly inserted in the fixing support part 3, but the hinge device 1 engaged to the door 2 is rotatable about the shaft part 12, so the door 2 may be swung open or close when a user pulls or pushes the door 2. Part of the building in which the end part 121 of the hinge device 1 connected to the door 2 and the rotary shaft 5 are inserted, may be called a door frame including the fixing support part 3. Referring to FIGS. 1 and 2, the hinge device 1 is installed at a lower side of the door 2, but the hinge device 1 may be installed at an upper side of the door 2. In this case, the fixing support part 3 is installed on top of the building, and the rotary shaft 5 is formed at a lower side of the door 2 and is rotatably inserted into a lower side of the building. The hinge device 1 may be easily installed at an upper end or a lower end of the door 2, thus saving construction cost.

The engaging accommodation part 11 is engaged to the door 2 and moves together and is configured to accommodate fluid, the shaft part 12, the movement part 13 and the elastic part 14 which will be described in details later and comprises an accommodation part body 111, a cap 112 and a holder 113.

The accommodation part body 111 forms an exterior of the engaging accommodation part 11 and comprises a door engaging part 111a, an accommodation space part 111b, a cap engaging part 111c, a holder engaging part 111d, a fluid flow passage 111e, a hydraulic pressure adjusting passage 111f, a hydraulic pressure adjusting part 111g and a bearing mounting groove 111h.

The door engaging part 111a is depressed on top of the accommodation part body 111, so an end of the door 2 is inserted. Since the door 2 is fixedly inserted in the door engaging part 111a, the hinge device 1 may be stably engaged to the door 2.

The accommodation space part 111b is an empty space formed in the interior of the accommodation part body 111 and preferably has a predetermined shape, and more preferably has a cylindrical shape. In the accommodation space part 111b are inserted the fluid, the shaft part 12, the movement part 13 and the elastic part 14, and the fluid may be hydraulic pressure oil. The accommodation space part 111b may be divided into three parts by means of the movement part 13. The movement part 13 and the construction of the same will be described in details later.

The cap engaging part 111c is depressed on one side surface of the accommodation part body 111 and communicates with the accommodation space part 111b and is configured to position the fluid, the movement part 13 and the elastic part 14 through the cap engaging part 111c into the accommodation space part 111b.

The holder engaging part 111d is depressed on in a lower side of the accommodation part body 111 and communicates with the accommodation space part 111b and is configured to position the shaft part 12 through the holder engaging part 111d into the accommodation space part 111b.

The fluid flow passages 111e are depressed at regular intervals on an inner surface of the accommodation part body 111 and are connected, thus allowing the fluid of the accommodation space part 111b to flow. Referring to FIGS. 2, 3 and 9, a pair of the fluid flow passages 111e are installed at front and rear sides with a predetermined interval between them. Here, the fluid flow passage 111e formed at the front side is called a first fluid flow passage 111e′, and the fluid flow passage 111e formed at the rear side is called a second fluid flow passage 111e″. The portion depressed on an inner surface of the accommodation part body 111 near the cap engaging part 111c is called first depressed fluid flow passages 111ea′ and 111ea″, and the portion depressed at a predetermined interval from the first depressed fluid flow passages 111ea′ and 111ea″ is called second depressed fluid flow passages 111eb′ and 111eb″. The portions interconnecting the first depressed fluid flow passages 111ea′ and 111ea″ and the second depressed fluid flow passages 111eb′ and 111eb″ are called connection fluid flow passages 111ec′ and 111ec″. Here, the first fluid flow passage 111e′ is formed longer than the second fluid flow passage 111e″. The fluid flow passage 111e is opened or closed in accordance with reciprocation of the movement part 13. The operations thereof will be described in details later.

The hydraulic pressure adjusting passage 111f is depressed on an outer side surface of the accommodation part body 111 and communicates with the fluid flow passage 111e. A hydraulic pressure adjusting part 111g is inserted in the hydraulic pressure adjusting passage 111f. The hydraulic pressure adjusting passage 111f communicating with the first fluid flow passage 111e is called a first hydraulic pressure adjusting passage 111f′, and the hydraulic pressure adjusting passage 111f communicating with the second fluid flow passage 111e″ is called a second hydraulic pressure adjusting passage 111f″.

The hydraulic pressure adjusting passage 111g is inserted in the hydraulic pressure adjusting passage 111f, thus adjusting the amount of fluid flowing through the fluid flow passage 111e. It is formed in a long and circular cylinder shape and is thread-engaged to the accommodation part body 111. The amount of the fluid flowing through the fluid flow passage 111e adjusted by adjusting the depth that the hydraulic pressure adjusting part 111g is inserted in the hydraulic pressure adjusting passage 111f, thus controlling the hydraulic pressure of the hinge device 1. Here, the hydraulic pressure adjusting part 111g inserted in the first hydraulic pressure adjusting passage 111f′ is called a first hydraulic pressure adjusting part 111g′, and the hydraulic pressure adjusting part 111g inserted in the second hydraulic pressure adjusting passage 111f″ is called a second hydraulic pressure adjusting part 111g″. It is possible to make same or different the amount of fluid flowing through the first fluid flow passage 11e′ and the second fluid flow passage 111e″ through the hydraulic pressure adjusting part 111g.

The bearing mounting groove 111h is depressed on top of the inner surface of the accommodation part body 111. On the bearing mounting groove 111h is mounted a bearing 125 which surrounds the front part 124 of the shaft part 12.

The cap 112 is inserted in the cap engaging part 111c and is thread-engaged to the accommodation part body 111 for thereby opening or closing the cap engaging part 111c. A water tight member 114 is disposed between the accommodation part body 111 and the cap 112. Here, the water tight member 114 may be an O-ring.

The holder 113 is inserted in the holder engaging part 111d and is thread-engaged to the accommodation part body 111 for thereby closing the holder engaging part 111d. A water tight member 115 is disposed between the accommodation part body 111 and the holder 113. The holder 111, for example, may have a cylindrical shape whose top is open and may have a shaft pass through hole 113a which passes through from bottom and from which the end part 121 of the shaft part 12 protrudes.

The shaft part 12 is inserted through the holder engaging part 111d into the accommodation space part 111b, and an end of the shaft part protrudes from the engaging accommodation part 11 and is inserted in the fixing support part 3. The shaft part comprises an end part 121, an extension part 122, a protrusion part 123 and a front end part 124.

The end part 121 forms an end of the shaft part 12 and has a section of a non-circular shape and protrudes from a shaft pass through hole 113a of the holder 113 and is inserted in the fixing support part 3. The end part 121 has a non-circular shape and is inserted in the fixing support part 3, so when the door 2 is opened or closed, the shaft part 12 is fixed, not moving, even when the hinge device 1 moves together with the door 2.

The extension part 122 extends from a front end of the end part 121 and has a section of a circular shape. A bearing is inserted in a lower, outer end of the extension part 122. A water tight member 127 is inserted in a lower end of the extension part 122 for thereby preventing the fluid from leaking through a shaft tube hole 113a of the holder 113.

The protrusion part 123 eccentrically protrudes from an outer side surface of the extension part 122, so the roller 134a of the movement part 13 rolls along an outer side surface of the protrusion part 123 when the door 2 is swung open or close. On an outer side surface of the protrusion part 12 is provided a roller mounting part 123a which is inwardly grooved in order for one side surface of the roller 134a to be mounted thereon. Since the roller 134a is mounted on the roller mounting part 123a, the door 2 may maintain an open or closed state. A plurality of roller mounting parts 123a are formed at regular intervals on an outer side surface of the protrusion part 123, so the angle at which the door 2 is opened and fixed may be changed with the aid of the roller mounting parts 123a on which the roller 134a is mounted.

The front end part 124 has a predetermined diameter portion at the front end of the extension part 122, so a bearing 126 may be inserted into an outer surface thereof. The bearing 126 surrounding the front end part 124 is mounted on the bearing mounting groove 111h.

The movement part 13 is inserted through the cap engaging part 111c into the accommodation space part 111b and is connected to the shaft part 12 so that it can reciprocate in a longitudinal direction of the accommodation space part 111b and can rotate at a predetermined angle about the shaft part 12. Since the movement part 13 reciprocates in a longitudinal direction of the accommodation space part 111b, the fluid of the accommodation space part 111b may move, thus decelerating the speed at which the door 2 is opened or closed. The movement part 13 comprises a first head 131, a second head 132, a connection part 133, a roller part 134 and an opening and closing ball 135.

The first head 131 is configured to come into contact with the elastic part 14 and divide the accommodation space part 111b into two spaces. Hereinafter, the accommodation space part 111b of the left side divided by the first head 131 is called a first accommodation space 1111, and the accommodation space part 111b of the right side is called a second accommodation space 1112. The first head 131 has a predetermined shape, but preferably has a short, circular cylinder shape. The first head 131 comprises a fluid flow hole 131a and a support shoulder 131b.

The fluid flow hole 131a passes through the first head 131 by providing a space through which the fluid may pass. Since the door 2 is opened or closed, the movement part 13 reciprocates in a longitudinal direction in the accommodation space part 111b, so the fluid in the first accommodation space 1111 flows through the fluid flow hole 131a into the second accommodation space 1112, and the fluid in the second accommodation space 1112 flows into the first accommodation space 1111.

The support shoulder 131b protrudes from one side of the first head 131 and supports the roller 134a. A hollow part is formed at the support shoulder 131b, and the roller shaft 134b is inserted into the follow part.

The second head 132 is spaced apart at a predetermined interval from the first head 131 and is positioned in the accommodation space part 111b and divides the accommodation space part 111b into two spaces. Hereinafter, the accommodation space part 111b of the left side divided by the second head 132 is called a second accommodation space 1112, and the accommodation space part 111b of the right side is called a third accommodation space 1113. The second accommodation space 1112 means part of the accommodation space part 111b surrounded by the first head 131 and the second head 132. The second head 132 has a predetermined shape, but preferably has a short, circular cylinder shape. The second head 132 comprises a construction of the fluid flow hole 132a etc.

The fluid flow hole 132a passes through the second head 132 by providing a space through which the fluid can flow. An opening and closing ball 135 is inserted in the fluid flow hole 132a. The fluid flow hole 132a comprises a first through hole 1321 formed near the second space part 1112 and having a predetermined diameter, a second through hole 1322 which extends from the first through hole 1321 and is formed near the third space part 1113 and has a diameter larger than the first through hole 1321, and an engaging shoulder 1323 which protrudes from around an end of the second fluid flow hole 1322 and is configured to prevent the opening and closing ball 135 from disengaging from the fluid flow hole 132a.

The connection part 133 is disposed between the first head 131 and the second head 132 and is configured to interconnect the first head 131 and the second head 132. The connection part 133 has a predetermined shape, but preferably has a circular cylinder shape whose bottom surface is half cut in a flat shape. The connection part 133 comprises an insertion groove 133a, and a quick rotation prevention part 133b.

The insertion groove 133a passes through the connection part 133 from its top to bottom. The extension part 122 of the shaft part 12 is inserted in the insertion groove 133a. Part of the extension part 122 protrudes. As the door 2 is opened or closed, the movement part 13 rotates about the shaft part 12 and reciprocates in a longitudinal direction of the accommodation space part 111b. So, the insertion groove 133a is preferably characterized in that the curved surfaces of both sides of the horizontal cross section are formed in an elliptical shape corresponding to the curved shape of the extension part 122.

The quick rotation prevention part 133b protrudes from a lower surface of the connection part 133 near the second head 132. When the door 2 is closed, the movement part 13 abruptly and then slowly starts moving in a longitudinal direction of the accommodation space part 111b. When the contacting protrusion part 123 and roller 134a are disengaged, it comes into contact with the other side surface of the protrusion part 123, thus preventing quick rotations of the movement part 13.

The roller part 134 is formed at one side of the movement part 13 and comes into contact with an outer surface of the protrusion part 123 and comprises a roller 134a, and a roller shaft 134b.

The roller 134a is disposed between a lower surface of the connection part 133 and an upper surface of the support shoulder 131b and comes into contact with an outer surface of the protrusion part 123. The roller 134a has a predetermined shape and is made from a predetermined material, but preferably it has a ring shape and is made from a metallic material. The roller 134a is mounted on the roller mounting part 123a of the protrusion part 123 in a state that the door is closed and the door is fully opened and fixed. When the door 2 is being opened or closed, the roller 134a comes into contact with an outer side surface of the protrusion part 123 and rotates.

The roller shaft 134b is fixedly inserted in regular sequence into the support shoulder 131b, the roller 134a and the connection part 133. When the door 2 is opened or closed, the movement part 13 rotates about the shaft part 12, so the roller 134a rolls along an outer surface of the protrusion part 123. The roller part 134 is provided in pair at front and rear sides at a predetermined interval.

The opening and closing ball 135 is inserted in the fluid flow hole 132a and is movable therein. The opening and closing ball 135 has a predetermine diameter larger than the first pass through hole 1321, but smaller than the second pass through hole 1322. When the door 2 is opened, the fluid in the second accommodation space 1112 inflows through the first pass through hole 1321, thus allowing the opening and closing ball 135 to be positioned at the side of the second pass through hole 1322, so it moves into the third accommodation space 1113. When the door 2 is closed, the fluid in the third accommodation space 11113 inflows through the second pass through hole 1322, thus pushing the opening and closing ball 135 toward the first pass through hole 1321, so the opening and closing ball 135 blocks the first pass through hole 1321, whereby the fluid cannot move into the second accommodation space 1112 through the fluid flow hole 132a.

The elastic part 14 is positioned in the accommodation space part 111b, thus pressurizing the movement part 13. It may be an elastic spring. The elastic part 14 is disposed between one side surface of the interior of the accommodation part body 111 and an outer side surface of the first head 131 and is contracted or released when the movement part 13 reciprocates in a longitudinal direction of the accommodation space part 111b.

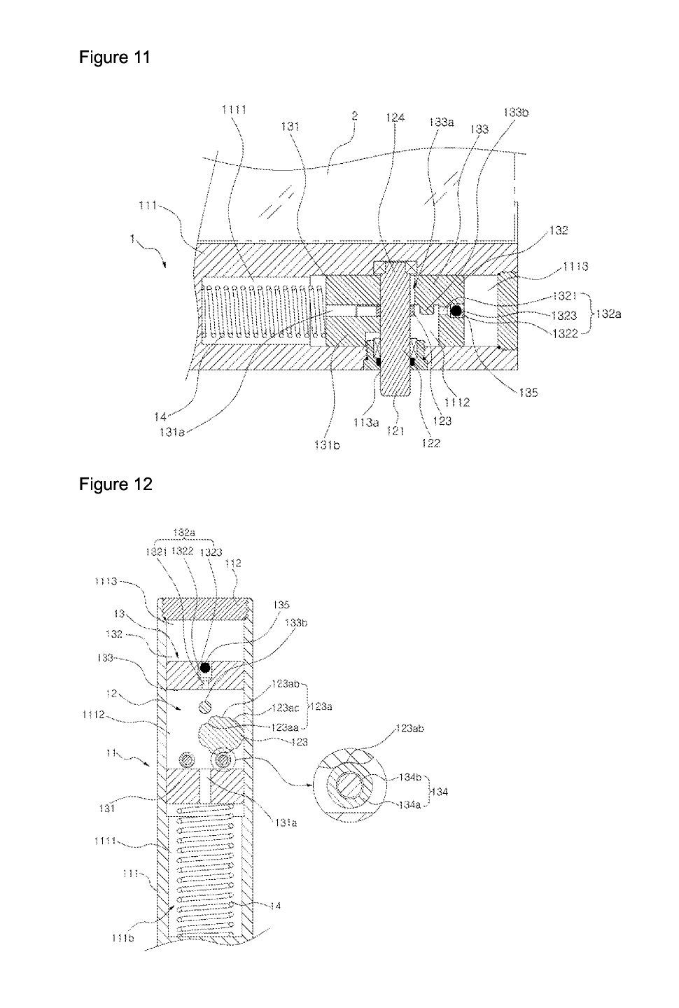

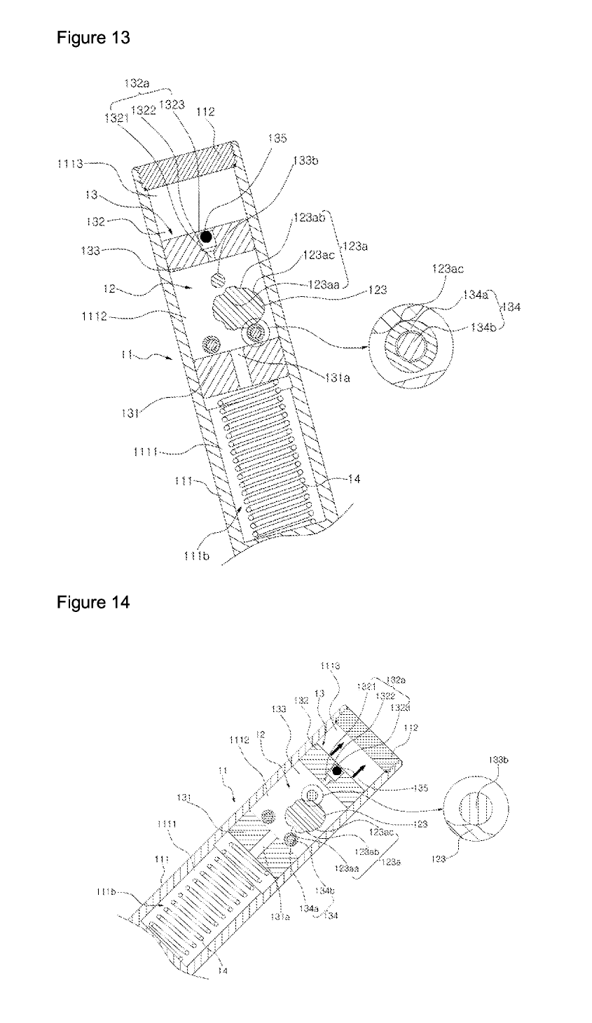

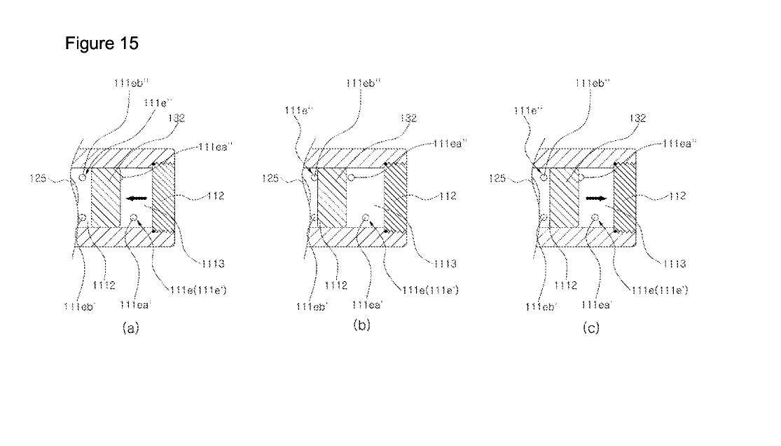

FIG. 10 is a cross sectional view taken along line B-B of FIG. 2 while illustrating a hinge device when a door is being opened, and FIG. 11 is a cross sectional view taken along line A-A of FIG. 2 while illustrating a hinge device when a door is opened at an angle of 90° and then is fixed, and FIG. 12 is a cross sectional view taken along line B-B of FIG. 2 while illustrating a hinge device when a door is opened at an angle of 90° and then is fixed, and FIG. 13 is a cross sectional view taken along line B-B of FIG. 2 while illustrating a hinge device when a door is opened at an angle of 105° and then is fixed, and FIG. 14 is a cross sectional view taken along line B-B of FIG. 2 while illustrating a hinge device when a door is being closed after it is opened and then is fixed, and FIG. 15 is a cross sectional view taken along line C-C of FIG. 2 while illustrating a hinge device in order to describe an operational procedure during which a second head opens a fluid flow passage as the door is opened or closed.

The operational procedures of the hinge device 1 having the above described construction will be described with reference to FIGS. 1 to 15.

Referring to FIGS. 1, 7, 8 and 9, when the door 2 of the right side is pushed in a state that the door 2 is closed, when viewing from the lower side, the door 2 rotates in a counterclockwise direction about the shaft part 12 and the rotary shaft 5, and the engaging accommodation part 11 engaged to the door 2 moves together, and the movement part 13 accommodated in the engaging accommodation part 11 rotates in a counterclockwise direction about the shaft part 12. As the movement part 13 rotates in a counterclockwise direction, the roller 134a departs from the roller mounting part 123aa and, as illustrated in FIG. 10, rolls along an outer side surface of the protrusion part 123. As the roller 134a rolls along an outer side surface of the protrusion part 123 which eccentrically protrudes from the extension part 122, the movement part 13 moves toward the elastic part 14, thus pressurizing the elastic part 14. At this time, the fluid in the first accommodation space 1111 moves through the fluid flow hole 131a into the second accommodation space 1112, and part of the fluid in the second accommodation space 1112 inflows through the first pass through hole 1321 of the second head 132 and pushes the opening and closing ball 135 toward the second pass through hole 1322, so the fluid moves through the fluid flow hole 132a into the third accommodation space 1113. While part of the fluid first moves through the first fluid flow passage 111e′ into the third accommodation space 1113, when the elastic part 14 is compressed, as illustrated in (a) of FIG. 15, the first depressed flow passage 111ea″ of the second fluid flow passage 111e″ is opened, so the fluid moves through the first fluid flow passage 111e′ and the second fluid flow passage 111e″. Since the fluid in the first accommodation space 1111 and the second accommodation space 1112 move into the second accommodation space 1112 and the third accommodation space 1113, it is possible to prevent the door from being easily opened.

When the door 2 is opened at an angle of 90°, referring to FIGS. 11 and 12 and (b) of FIG. 15, the roller 134a is mounted on the roller mounting part 123ab, so the door 2 is opened at an angle of 90° and is fixed, and the fluid does not flow through the fluid flow holes 131a and 132a and the fluid flow passage 111e. When the door 2 which is opened at an angle of 90° and is fixed is further pushed and rotates in a counterclockwise direction, as illustrated in FIG. 13, the roller 134a is mounted on the roller mounting part 123ac positioned at further right side as compared to the roller mounting part 123ab, so the door 2 can be opened at an angle of 105° and then can be fixed.

When the door 2 is pulled in a state that the door 2 is pushed open at an angle of 90° and is fixed, when viewing from lower side, the door 2 rotates in a clockwise direction about the shaft part 12 and the rotary shaft 5. As the door 2 rotates in a clockwise direction, the engaging part 11 engaged to the door 2 moves together, and the movement part 13 accommodated in the engaging accommodation part 11 rotates in a clockwise direction about the shaft part 12. As the movement part 13 rotates in a clockwise direction, the roller 134a departs from the roller mounting part 123ab and rolls along an outer side surface of the protrusion part 123. As the roller 134a rolls along an outer side surface of the protrusion part 123, the movement part 13 releases a pressurized state of the elastic part 14, and the elastic part 14 is loosened, and the movement part 13 moves in the opposite direction of the elastic part 14. Since the movement part 13 moves in the opposite direction of the elastic part 14, the fluid moves through the first fluid flow passage 111e′ and the second fluid flow passage 111e″ from the third accommodation space 1113 to the second accommodation space 1112. After a predetermined time, in a state that the door 2 is opened at an angle of 30°, as illustrated in (c) of FIG. 15, the first depressed fluid flow passage 111ea″ of the second fluid flow passage 111e″ is closed by means of the second head 132, and the fluid moves only through the first fluid flow passage 111e′, the closing speed of the door 2 may be decelerated. In this case, the opening and closing ball 135 at the second head 132 blocks the first pass through hole 1321 by means of the fluid inputted through the second pass through hole 1322, so the fluid in the third accommodation space 1113 cannot move through the fluid flow hole 132a into the second accommodation space 1112. Thereafter, in case that the door 2 is fully closed, as illustrated in FIGS. 7, 8 and 9, the roller 134a is mounted on the roller mounting part 123aa, so the fluid no longer moves.

On the other hand, in a state that the door 2 is opened and fixed, when the door 2 is closed, as described earlier, while the fluid in the third accommodation space 1113 moves through the first fluid flow passage 111e′ and the second fluid flow passage 111e″ into the second accommodation space 1112, the elastic part 14 is loosened, and the second fluid flow passage 111e″ is closed, and the fluid flows only through the first fluid flow passage 111e′, so suddenly the movement part 13 slowly moves in the opposite direction of the elastic part 14, and the contact between the outer side surface of the protrusion part 123 and the roller 134a is departed, whereby the door 2 may not be decelerated. The hinge device 1 comprises a quick rotation prevention part 133b at a lower surface of the connection part 133. As illustrated in FIG. 14, the other side surface of the protrusion part 123 comes into contact with the quick rotation prevention part 133b, so the rotation of the movement part 13 is decelerated. As the movement part 13 tends to keep rotating, the movement part 13 is pushed, and the roller 134a comes into contact again with one side surface of the protrusion part 123, and the movement part 13 moves in the opposite direction of the elastic part 14, and the fluid flows from the second accommodation space 1112 and the third accommodation space 1113 to the first accommodation space 1111 and the second accommodation space 1112.

In the hinge device 1, since the roller 134a rolls along an outer side surface of the protrusion part 123 when the door 2 is opened or closed, it is possible to conveniently open or close the door 2, and durability may be enhanced by reducing frictions between the parts, thus reducing errors in the device along with a longer service life. In addition, the hinge device 1 comprises a plurality of roller mounting parts 123 formed at regular intervals on an outer side surface of the protrusion part 123. So, it is possible to adjust the angle at which the door 2 is opened and then fixed in such a way to change the roller mounting parts 123a on which the roller 134 is mounted. In addition, there is further provided a quick rotation prevention part 133b which comes into contact with one side surface of the protrusion part 123 when the contacting protrusion part 123 and roller 134a is departed while the door 2 is closed, by which it is possible to prevent any accident in advance which may occur when the door 2 is suddenly closed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A door hinge device using hydraulic pressure so that a door can be opened or closed through rotations, comprising:
an engaging accommodation part which is engaged to the door and moves together with the door and includes an accommodation space part configured to accommodate fluid;
a shaft part which is disposed in the accommodation space part and of which one end protrudes from the engaging accommodation part and is fixed at a door frame;
a movement part which is disposed in the accommodation space part and is connected to the shaft part so that the movement part reciprocates in a longitudinal direction of the accommodation space part and rotates at a predetermined angle about the shaft part; and
an elastic part which is disposed in the accommodation space part and is configured to pressurize an end of the movement part,
wherein the shaft part comprises a protrusion part eccentrically protruding from an outer side surface, and the movement part comprises a roller part formed at one side and having a roller rolling about a roller shaft, and when the door is opened, the movement part rotates about the shaft part, and the roller rolls along an outer side surface of the protrusion part, so the movement part moves in a longitudinal direction of the accommodation space part, thus pressurizing the elastic part.

2. The device of claim 1, wherein the protrusion part comprises a roller mounting part which is depressed from an outer side surface to an inner side, one side surface of the roller being mounted on the roller mounting part, and the door can be opened and fixed in such a way that the roller is mounted on the roller mounting part.

3. The device of claim 2, wherein there are provided a plurality of the roller mounting parts at regular intervals on an outer side surface of the protrusion part, so the angle at which the door is opened and then fixed can be changed based on the roller mounting part on which the roller is mounted.

4. The device of claim 1, wherein the movement part further comprises a quick rotation prevention part which is formed at one side and comes into contact with the protrusion part when the contacting protrusion part and roller is departed while the door is being closed, for thereby preventing quick rotations of the movement part.

5. The device of claim 1, wherein the movement part further comprises a first head contacted with elastic part, a second head disposed at a predetermined interval from the first head, and a connection part interconnecting the first head and the second head, wherein the first head and the second head each include a fluid flow hole which is passed through for fluid to flow.

6. The device of claim 5, wherein the movement part further comprises an opening and closing ball movably disposed in the fluid flow hole of the second head, and the fluid flow hole of the second head comprises a first pass through hole formed near the connection part and having a predetermined diameter, and a second pass through hole which extends from the first pass through hole and has a diameter larger than that of the first pass through hole, and the opening and closing ball has a diameter larger than that of the first pass through hole, but smaller than that of the second pass through hole.

7. The device of claim 5, wherein the first head further comprises a support shoulder protruding from one side surface and configured to support the roller, and the roller is disposed between a lower surface of the connection part and an upper surface of the support shoulder, and the roller shaft is fixedly inserted in regular sequence in the support shoulder, the roller and the connection part.

8. The device of claim 5, wherein the engaging accommodation part is depressed on an inner surface at a predetermined interval and is connected and comprises a fluid flow passage through which the fluid of the accommodation space part flows, and as the door is opened and closed, the second head opens or closes the fluid flow passage.

9. The device of claim 8, wherein the engaging accommodation part is depressed on an outer surface and communicates with the fluid flow passage and further comprises a hydraulic pressure adjusting passage in which a hydraulic pressure adjusting part is inserted so as to adjust the amount of fluid flowing through the fluid flow passage.

10. The device of claim 8, wherein the fluid flow passage is installed in pair at a front side and a rear side at a predetermined interval, and one fluid flow passage is shorter than the other fluid flow passage, so when the movement part moves in a longitudinal direction of the accommodation space part, the second head opens or closes the one fluid flow passage.
